(19) United States
(12) Patent Application Publication
(10) Pub. No.: US 2012/0181315 A1
(43) Pub. Date: Jul. 19, 2012

(54) IN-VEHICLE FIXTURE FOR DRIVING ASSIST DEVICE

(76) Inventor: Tien-Te LAI, Hsinchu City (TW)

(21) Appl. No.: 13/158,688

(22) Filed: Jun. 13, 2011

(30) Foreign Application Priority Data
Jan. 17, 2011 (TW) 100101678

(51) Int. Cl. B60R 11/00

(52) U.S. Cl. 224/567

(57) ABSTRACT

An in-vehicle fixture for driving assist devices has a hanging seat, at least one contact arm and at least one first connection member. The hanging seat has a saddle portion formed on a bottom of the hanging seat and hung on a fixing rod of a rearview mirror of a vehicle. One end of each one of the at least one contact arm is connected with the hanging seat, and the other end abuts against one of an inside surface of the windshield, an inner roof of the vehicle and a junction between the inside surface of the windshield and the inner roof. Each one of the at least one first connection member is formed on the hanging seat and is directly connected with a second connection member formed on a driving assist device so that the hanging seat can be easily firmly mounted.

### BACKGROUND OF THE INVENTION

1. Field of the Invention

The present invention relates to a fixture, and more particularly to in-vehicle fixture for driving assist device.

2. Description of the Related Art

Driving recorders are popular vehicle equipment among driving assist devices recently for recording and playback of front, rear and side views of a vehicles and are usually mounted inside the vehicle and near the windshield.

With reference to FIG. 23, a conventional fixture for a driving recorder is mounted inside an external review mirror 17. The external rearview mirror 17 is fastened on an original rearview mirror 8 with clips 13 to provide a wide range of viewing angles. Some of the original rearview minors 8 have an automatic anti-glare function at night avoiding high beam from vehicles behind to be reflected on the rearview mirrors 8 so as to secure driving safety at night. However, the mounting of the driving recorder can invalidate the automatic anti-glare function of the rearview minors 8.

With reference to FIG. 24, another conventional fixture 27 for a driving recorder 5 is shown. The driving recorder 5 is connected with one side of the fixture 27 and has a sucking disc 18. The sucking disc 18 is mounted on the other side of the fixture 27 and is attached on an inside surface of a windshield together with the driving recorder 5. The sucking disc 18 is subjected to the combined weight of the fixture 27 and the driving recorder 5 at the same time. When a collision occurs, the fixture 27 and the driving recorder 5 may come off the windshield and fall, affect the function of the driving recorder 5 and endanger the safety of the onboard passengers.

Other substitute, such as adhesive tape, in the market is used to replace the foregoing sucking disc 18 for attaching the fixture and the driving recorder to the windshield but has the following disadvantages:

1. Once attached to the windshield, the windshield is not easily replaced.

2. Windshields of many vehicles have heat-insulating films affixed thereon. When the fixtures and the driving recorders sway for being unstably attached on the windshield, they may scratch and damage the expensive heat-insulating films.

3. When the driving recorder is no longer in use or will be replaced by other driving recorder, the residual glue on the windshield is hard to be removed and is destructive especially when a volatile solute is applied to remove the residual glue on the heat-insulating film made of a plastic material.

Another conventional fixture for driving recorder is available in the market to fix the driving recorder on a visor in the front of a vehicle through a clamp. The clamp has a set of revolute joints. In view of the visor being swivellable, the set of revolute joints are not firmly fastened on the visor. Besides, the visor is easy to be wobbled during a bumpy drive, and so are the recorded frames of the driving recorder. Furthermore, when the driving recorder is fastened on the visor through the clamp to record, the visor must be fixed and cannot be flipable. On the contrary, when the visor needs to be flipable, the driving recorder is not adequately positioned for recording.

### SUMMARY OF THE INVENTION

An objective of the present invention is to provide an in-vehicle fixture for driving assist devices easily and stably mounted inside a vehicle together with at least one driving assist device.

To achieve the foregoing objective, the in-vehicle fixture for driving assist device mounted on a fixing rod of a rearview mirror inside a vehicle has a hanging seat, at least one contact arm and at least one first connection member.

The hanging seat has a saddle portion and adapted to be hung on the fixing rod.

One end of each one of the at least one contact arm connected with the hanging seat.

The at least one first connection member are formed on the hanging seat.

Preferably, the at least one first connection member is adapted to respectively connect with at least one second connection member formed on a driving assist device.

Preferably, the at least one contact arm protrudes forwardly.

Preferably, the hanging seat further has a rear nose formed on and protruding rearwardly from a rear of the hanging seat.

Preferably, the at least one contact arm protrudes rearwardly.

Preferably, the hanging seat further has a front nose formed on and protruding forwardly from a front of the hanging seat.

Preferably, the hanging seat is composed of two bars pivotally connected with each other, one bar has a left hanging seat formed on one end thereof and the other bar has a right hanging seat formed on one end thereof.

Preferably, the two bars are crossly and pivotally connected, and

the at least one contact arm has a left contact arm and a right contact arm, the left contact arm is formed on the end of the bar away from the right hanging seat, and the right contact arm is formed on the end of the bar away from the left hanging seat.

Preferably, each bar has a protrusion formed on and protruding from a middle portion of the bar in a direction toward the other bar, and the two protrusions are pivotally connected, and the at least one contact arm has a left contact arm and a right contact arm, the right contact arm is formed on the end of the bar away from the right hanging seat, and the left contact arm is formed on the end of the bar away from the left hanging seat.

Preferably, the each one of the at least one contact arm is a resilient bar.

Preferably, the hanging seat has a horizontal groove formed in a portion of the hanging seat directly above the saddle portion, and the at least one contact arm has two contact arms, and a horizontal bar is integrally formed between two contact arms and is pivotally mounted in the horizontal groove.

Preferably, the hanging seat has at least one C-shaped collar formed thereon, and the at least one contact arm has two contact arms, and a horizontal bar is integrally formed between two contact arms and is pivotally mounted in the C-shaped collar.

Preferably, the hanging seat has a hook formed on a top of the hanging seat.

Preferably, the in-vehicle fixture further has an intermediate mechanism, and the at least one first connection member is respectively connected with at least one third connection member formed on the intermediate mechanism.

Preferably, the intermediate mechanism further has a revolute joint.

The in-vehicle fixture is mounted on the fixing rod of the rearview mirror by using the saddle portion to stride over the fixing rod. One end of each contact arm abuts against one of an inside surface of the windshield, an inner roof of the vehicle and a junction between the inside surface of the windshield and the inner roof and an elastic force exerted by one end of each contact arm abuts against one of the inside surface of the windshield, the inner roof of the vehicle, the junction between the inside surface of the windshield and the inner roof, a place between the fixing rod and the inner roof, a place between the fixing rod and the inside surface of the windshield and a junction among the fixing rod, the inside surface of the windshield and the inner roof. The at least one first connection member is respectively connected with the at least one second connection member or the intermediate mechanism so as to achieve a purpose of easy mounting. In contrast to conventional technique, the in-vehicle fixture has the following advantages:

1. The in-vehicle fixture can be easily mounted and dismounted inside the vehicle with the weight of the driving assist device or the weight of the in-vehicle fixture.

2. The in-vehicle fixture can be fixed inside the vehicle by the elastic force generated by bending the contact arms and pushing the contact arms against an place inside the vehicle, making mounting of the in-vehicle fixture easier and more stable.

3. Mounting of the in-vehicle fixture does not include an adhesive bonding method, and the in-vehicle fixture can be fixed without damaging the heat-insulating film affixed on the inside surface of the windshield.

4. The in-vehicle fixture can be mounted between the inside surface of the windshield and the rearview mirror and does not block the view in front of the vehicle.

5. As the fixing rod of the rearview mirror is formed on a central top of the rearview mirror, a better recording position and angle can be obtained if the driving recorder is fixed on the fixing rod of the rearview mirror through the in-vehicle fixture (the hanging seat, the contact arms and the first connection member), and a better signal receiving can be obtained if a GPS or a mobile communication device are fixed on the fixing rod through the in-vehicle fixture.

6. When the contact arms are separately formed on the left and right of the top of the hanging seat, the contact arms and the hanging seat constitute three stable acting points, thereby preventing the driving assist devices from shaking and securing mounting of the in-vehicle fixture.

7. When the contact arms are resilient bars, the contact arms can not only prevent the in-vehicle fixture from vibrating and wavering but also fixing the in-vehicle fixture.

8. A combination of the hanging seat and the driving assist device or that of the hanging seat and the intermediate mechanism can form a hollow ring for entire in-vehicle fixture and the driving assist device to be hung on the fixing rod of the rearview mirror. Accordingly, when the vehicle incurs a collision, the in-vehicle fixture and the driving assist device are uneasy to come off and safety enhancement is achieved.

9. The hanging seat is connected to multiple driving assist devices through a branching means of the intermediate mechanism. For example, the hanging seat is connected with an intermediate mechanism, and the intermediate mechanism further branches to connect with a driving recorder and a GPS.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of an in-vehicle fixture for driving assist devices in accordance with the present invention;

FIG. 2 is an operational side view of the in-vehicle fixture in FIG. 1 mounted inside a vehicle;

FIG. 3 is an exploded perspective view of a second embodiment of an in-vehicle fixture for driving assist devices in accordance with the present invention;

FIG. 4 is an exploded perspective view of a third embodiment of an in-vehicle fixture for driving assist devices in accordance with the present invention;

FIG. 5 is an operational side view of the in-vehicle fixture in FIG. 4 mounted inside a vehicle;

FIG. 6 is an exploded perspective view of a fourth embodiment of an in-vehicle fixture for driving assist devices in accordance with the present invention;

FIG. 7 is an operational side view of the in-vehicle fixture in FIG. 6 mounted inside a vehicle;

FIG. 8 is an exploded perspective view of a fifth embodiment of an in-vehicle fixture for driving assist devices in accordance with the present invention;

FIG. 9 is an operational side view of the in-vehicle fixture in FIG. 8 mounted inside a vehicle;

FIG. 10 is an operational perspective view of a sixth embodiment of an in-vehicle fixture for driving assist devices in accordance with the present invention;

FIG. 11 is an exploded perspective view of a seventh embodiment of an in-vehicle fixture for driving assist devices in accordance with the present invention;

FIG. 12 is an exploded perspective view of an eighth embodiment of an in-vehicle fixture for driving assist devices in accordance with the present invention;

FIG. 13 is an exploded perspective view of a ninth embodiment of an in-vehicle fixture for driving assist devices in accordance with the present invention;

FIG. 14 is an exploded perspective view of a tenth embodiment of an in-vehicle fixture for driving assist devices in accordance with the present invention;

FIG. 15 is an operational side view of the in-vehicle fixture in FIG. 14 mounted inside a vehicle;

FIG. 16 is an exploded perspective view of an eleventh embodiment of an in-vehicle fixture for driving assist devices in accordance with the present invention;

FIG. 17 is a perspective view of the in-vehicle fixture in FIG. 16;

FIG. 18 is an exploded perspective view of a twelfth embodiment of an in-vehicle fixture for driving assist devices in accordance with the present invention;

FIG. 19 is a perspective view of the in-vehicle fixture in FIG. 18;

FIG. 20 is a perspective view of a thirteenth embodiment of an in-vehicle fixture for driving assist devices in accordance with the present invention;

FIG. 21 is a partially exploded perspective view of a fourteenth embodiment of an in-vehicle fixture for driving assist devices in accordance with the present invention;

FIG. 22 is an operational side view of the in-vehicle fixture in FIG. 21 mounted inside a vehicle;

FIG. 23 is an operational side view of a conventional in-vehicle fixture for driving assist devices mounted inside a vehicle; and

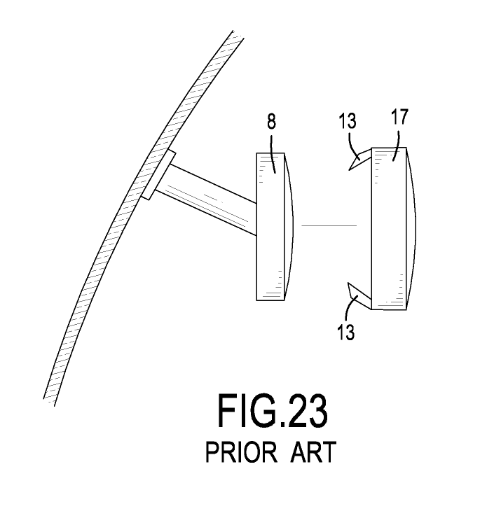

FIG. 24 is an operational side view of another conventional in-vehicle fixture for driving assist devices connected with a driving recorder.

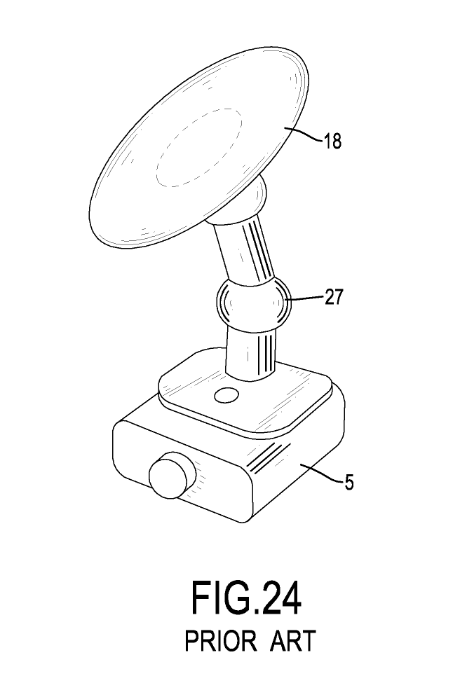

### DETAILED DESCRIPTION OF THE INVENTION

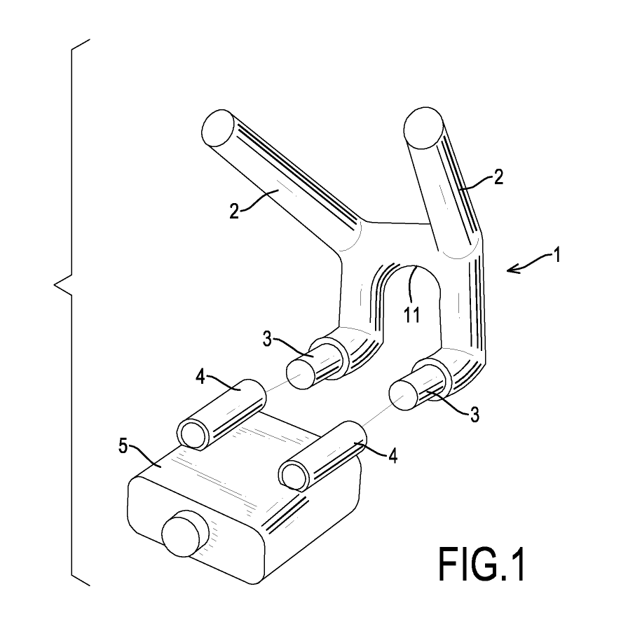

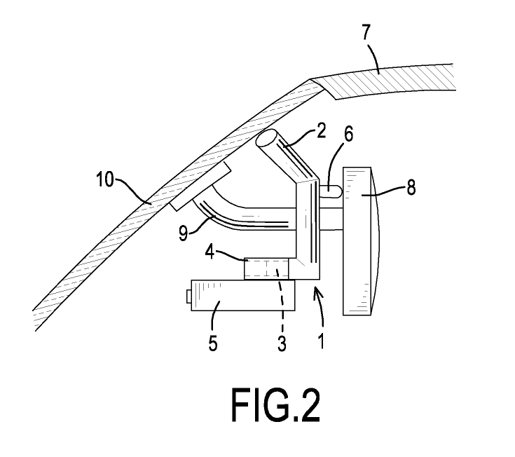

With reference to FIGS. 1 and 2, a first embodiment of an in-vehicle fixture for driving assist devices in accordance with the present invention has a hanging seat 1, two contact arms 2 and two first connection members 3.

The hanging seat 1 is integrally formed, takes the form of an inverted U, and has a saddle portion 11 and a rear nose 6. The saddle portion is formed on and recessed upwardly from a bottom of the hanging seat 1. The rear nose 6 is formed on and protrudes from a rear top of the hanging seat 1.

Each contact arm 2 is rod-like. One end of the contact arm 2 is integrally connected with the hanging seat 1. The connection means may be one of glue connection, engagement, clamping, bolt connection, riveting, sleeve connection revolute joint and integrally forming. In the present embodiment, the contact arms 2 are two rods separately and integrally formed on and protruding from a top of the hanging seat 1.

The first connection members 3 are formed on the hanging seat 1 and may be one of bolt, nut, hole, pin, slot, fixture, sleeve, revolute joint, magnet, glue connection and the like. In the present embodiment, each first connection member 3 is a pin formed on and protruding from the bottom of the hanging seat 1 in a direction away from a rearview mirror 8.

The hanging seat 1 is hung on the rearview mirror 8 by using the saddle portion 11 to stride over a fixing rod 9 of the rearview mirror 8. A top of each contact arm 2 prods at or abuts against one of an inner roof 7 of a vehicle, an inside surface of a windshield 10 and a junction of the inner roof 7 and the inside surface of the windshield 10. In the present embodiment, each contact arm 2 abuts against the inside surface of the windshield 10. The rear nose 6 abuts against a side of the rearview minor 8 facing the rear of the hanging seat 1.

The hanging seat 1 may be connected with a driving assist device 5 having two second connection members 4 formed thereon and respectively corresponding to the first connection members 3 of the in-vehicle fixture. In the present embodiment, each second connection member 4 is a sleeve, and the hanging seat 1 is mounted on the driving assist device 5 by respectively inserting the contact arms 3 into the sleeves. Accordingly, the hanging seat 1 can be easily and firmly connected with the driving assist device 5. With the weight of the driving assist device 5 and the multi-point abutment of the rear nose 6 and the contact arms 2, the in-vehicle fixture and the driving assist device 5 can be stably hung on the fixing rod 9 of the rearview minor 8.

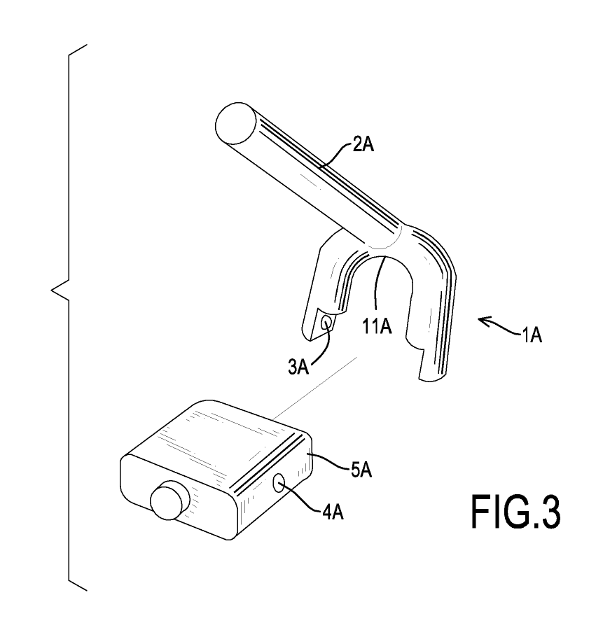

With reference to FIG. 3, a second embodiment of an in-vehicle fixture for driving assist devices in accordance with the present invention has a hanging seat 1A, a contact arm 2A and two first connection members 3A. The hanging seat 1A has a saddle portion 11A formed on and recessed upwardly from a bottom of the hanging seat 1A. The contact arm 2A is rod-like and one end of the contact arm 2A is integrally connected with a top of the hanging seat 1A. Each first connection member 3A is a bump formed on one of two sides of the saddle portion 11A facing each other. A driving assist device 5A has two second connection members 4A on two sides of the driving assist device 5A respectively corresponding to the first connection members 3A. The second connection members are indentations respectively formed in two sides of the driving assist device 5A facing each other and corresponding to the bumps The driving assist device 5A is connected with the hanging seat 1A by respectively engaging the first connection members 3A and the second connection members 4A. Alternatively, each first connection member 3A may be a slot formed in one of two sides of the hanging seat 1A, and each second connection member 4A is a block formed on and protruding from one of two sides of the driving assist device 5A.

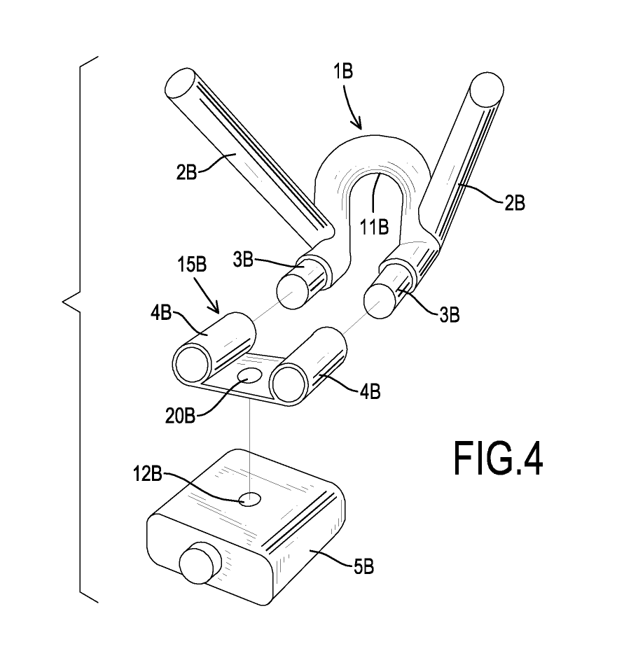

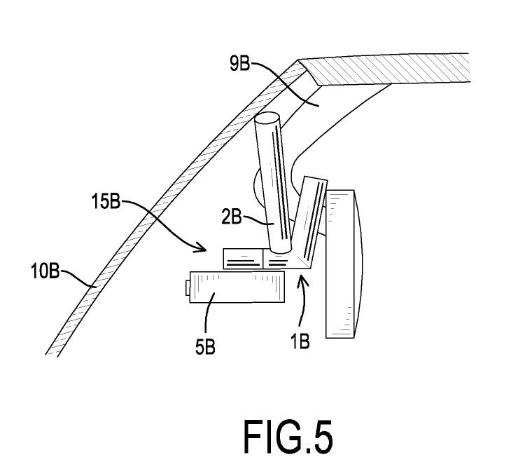

With reference to FIGS. 4 and 5, a third embodiment of an in-vehicle fixture for driving assist devices in accordance with the present invention has a hanging seat 1B, two contact arms 2B and two first connection members 3B. The hanging seat 1A has a saddle portion 11A formed on and recessed upwardly from a bottom of the hanging seat 1A. Each contact arm 2B is formed on and protrudes upwardly from a top of the hanging seat 1B. Each first connection member 3B is a pin formed on and protruding forwardly from two bottom portions of the hanging seat 1B. The driving assist device 5B has an intermediate mechanism 15B mounted on the driving assist device 5B. The intermediate mechanism 15B has a third connection member 20B formed thereon and the driving assist device 5B has a fourth connection member 12B formed thereon and corresponding to the third connection member 20B. As pertaining to a prior art, the technique of combining the third connection member 20 B and the fourth connection member 12B is not discussed here. The intermediate mechanism 15B further has two second connection members 4B formed thereon and respectively corresponding to the first connection members 3B. In the present embodiment, each second connection member is a sleeve. The driving assist device 5B is combined with the hanging seat 1B by respectively inserting the first connection members 3B into the second connection members 4B. With reference to FIG. 5, the hanging seat 1B is hung on the fixing rod 9B of the rearview mirror by using the saddle portion 11B to stride over the fixing rod 9B, and the contact arms 2B abut against an inside surface of the windshield 10B.

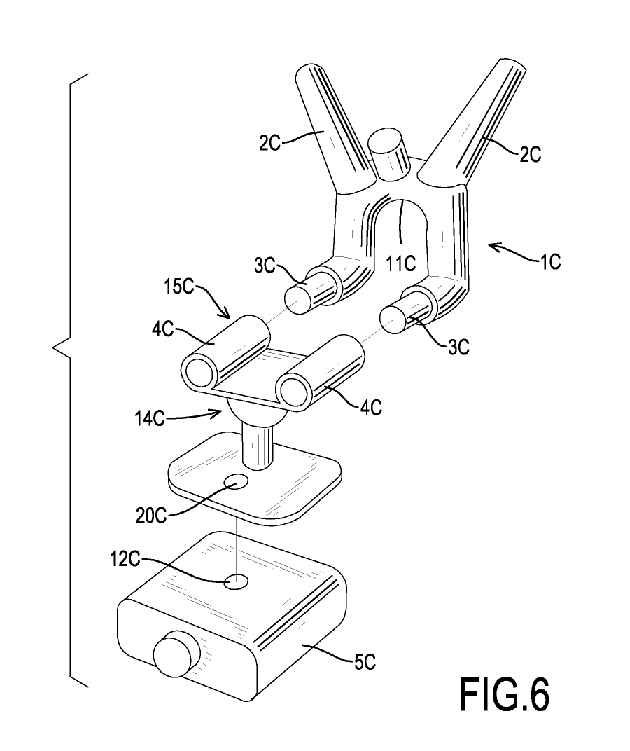

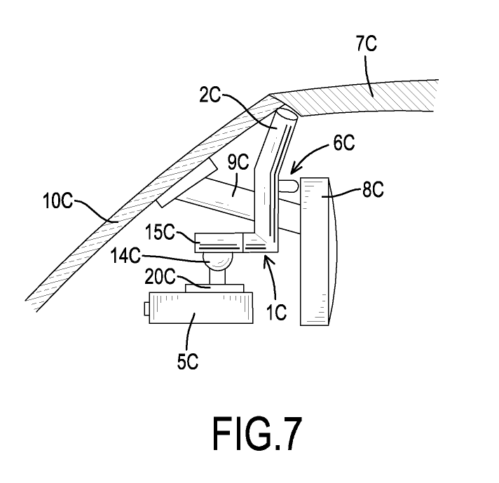

With reference to FIGS. 6 and 7, a fourth embodiment of an in-vehicle fixture for driving assist devices in accordance with the present invention has a hanging seat 1C, two contact arms 2C and two first connection members 3C. The hanging seat 1C has a saddle portion 11C and a rear nose 6C. The saddle portion 11C is formed on and recessed upwardly from a bottom of the hanging seat 1C. The rear nose 6C is formed on and protrudes from a rear top of the hanging seat 1C. The contact arms 2C are two rods separately and integrally formed on and protruding upwardly from a top of the hanging seat 1 and toward the rearview mirror 8C. Each first connection member 3C is a pin formed on and protruding from the bottom of the hanging seat 1C in a direction away from a rearview mirror 8C. When the in-vehicle fixture is mounted inside the vehicle, the hanging seat 1C is mounted on the fixing rod 9C of the rearview mirror 8C by using the saddle portion 11C to stride over the fixing rod 9C. The contact arms 2C protrude upwardly toward the rearview mirror 8C so as to abut against a junction between the windshield 10C and an inner roof 7C. The driving assist device 5C has an intermediate mechanism 15C mounted on the driving assist device 5C. The intermediate mechanism 15C has two second connection members 4C formed thereon. Each second connection member is a sleeve. The first connection members 3C are respectively mounted in the second connection members 4C so that the hanging seat 1C is combined with the intermediate mechanism 15C. The intermediate mechanism 15C further has a revolute joint 14C mounted on a bottom of the intermediate mechanism 15C. In the present embodiment, the revolute joint 14 is a universal joint. The driving assist device 5C further has a third connection member 20C mounted on a bottom of the revolute joint 14C. The third connection member 20C is connected with a fourth connection member 12C formed through the driving assist device 5C.

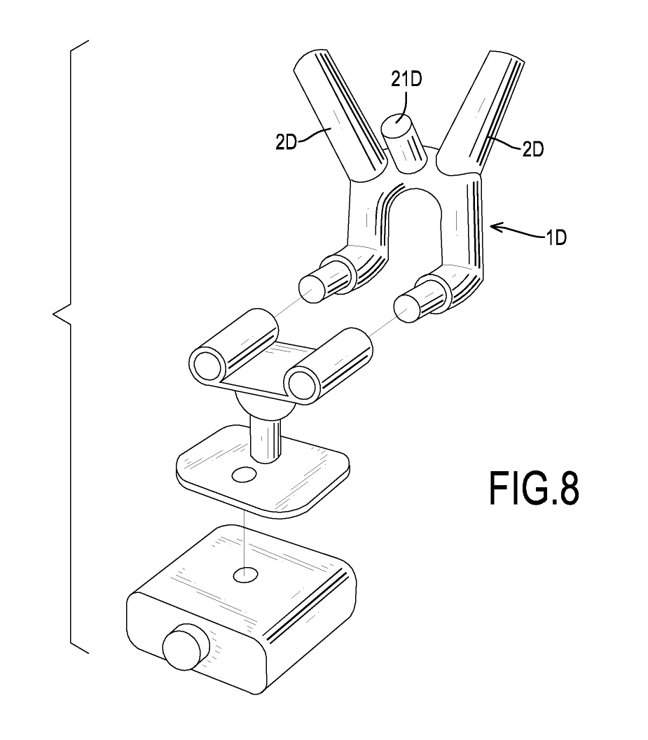

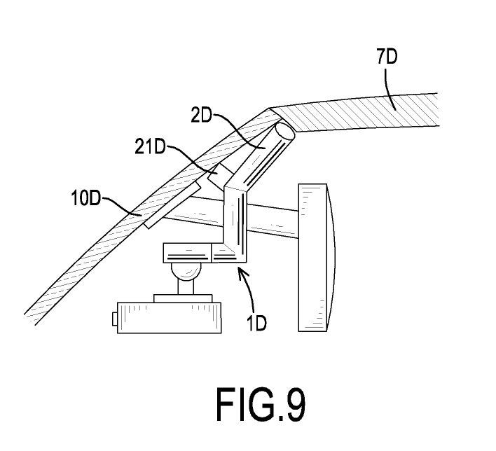

With reference to FIGS. 8 and 9, a fifth embodiment of an in-vehicle fixture for driving assist devices in accordance with the present invention is redesigned based on the fourth embodiment in FIG. 6. The fifth embodiment structurally differs from the fourth embodiment in the hanging seat 1D having no rear nose. Instead, the hanging seat 1D has a front nose 21D formed on and protruding forwardly from a top of the hanging seat 1D. When the contact arms 2D abuts against a junction between the inside surface of the windshield 10D and the inner roof 7D, the front nose 21D further abuts against the inside surface of the windshield 10D at the same time to more firmly mount the in-vehicle fixture.

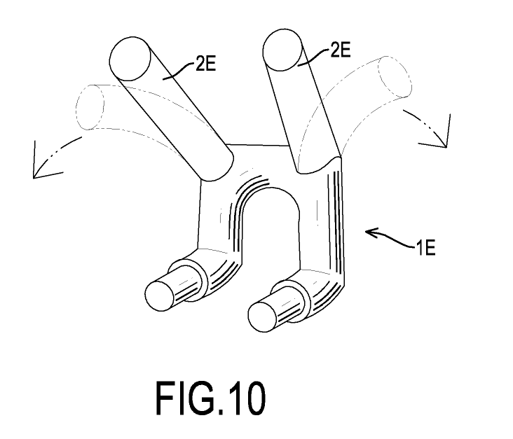

With reference to FIG. 10, a sixth embodiment of an in-vehicle fixture for driving assist devices in accordance with the present invention, which is redesigned based on the foregoing first embodiment in FIG. 1, is shown. The two contact arms 2E connected with the hanging seat 1E are made of resilient material so that the contact arms 2E can be bent resiliently to generate the elastic force for fixing the in-vehicle fixture inside the vehicle.

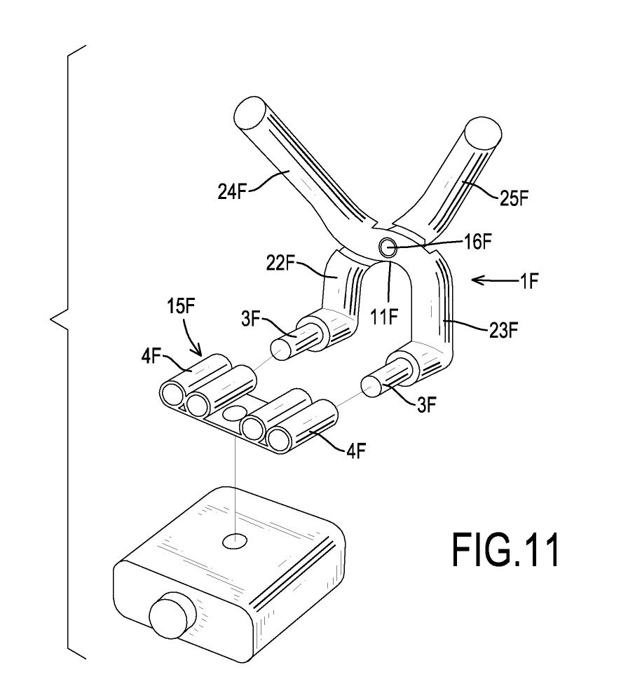

With reference to FIG. 11, a seven embodiment of an in-vehicle fixture for driving assist devices in accordance with the present invention has a hanging seat 1F. The hanging seat 1F is composed of two bars and one pivot element 16F. The two bars are crossly connected at middle portions thereof and the pivot element 16F is pivotally mounted at the intersection of the two bars so that the two bars can be pivotable relative to each other. The hanging seat 1F has a left hanging seat 22F, a right hanging seat 23F, a left contact arm 24F, a right contact arm 25F and two first connection members 3F. The left hanging seat 22F and the right contact arm 25F are two ends of one of the two bars respectively, and the right hanging seat 23F and the left contact arm 24F are two ends of the other bar respectively. The first connection members 3F are respectively formed on and protrude forwardly from bottoms of the left hanging seat 22F and the right hanging seat 23F. As the left hanging seat 22F and the right hanging seat 23F are pivotable relative to each other, a saddle portion 11F formed by the left hanging seat 22F and the right hanging seat 23F has a width adjustable function so as to correspond to different thickness of the fixing rod of the rearview mirror. The intermediate mechanism 15F further has at least four second connection members 4F to selectively correspond to the first connection members 3F formed on the width adjustable saddle portion 11F. Each second connection member 4F is a sleeve to correspond to one of the first connection member 3F so that the first connection members 3F on the left hanging seat 22F and the right hanging seat 23F can be selectively inserted into the corresponding second connection members 4F of the intermediate mechanism 15F.

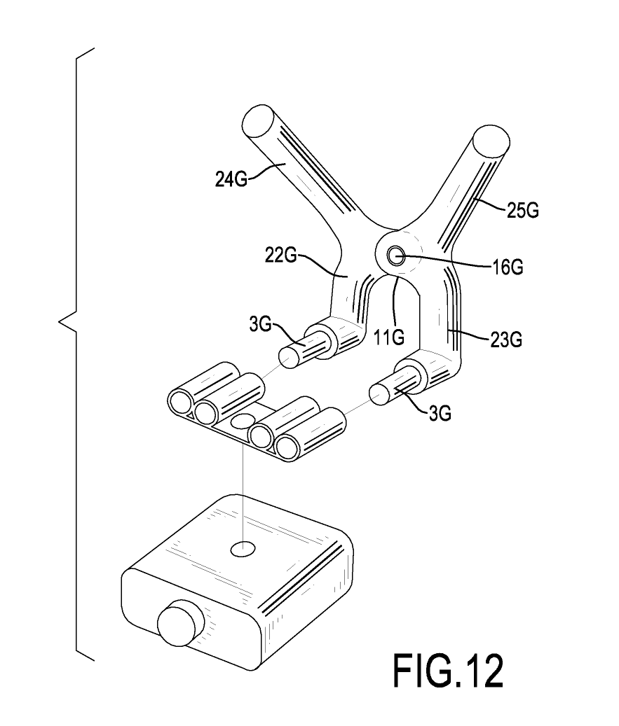

With reference to FIG. 12, an eighth embodiment of an in-vehicle fixture for driving assist devices in accordance with the present invention is redesigned based on the seventh embodiment in FIG. 11 and has a hanging seat. The hanging seat has two bars. Each bar has a protrusion formed on and protruding from a middle portion of the bar in a direction toward the other bar, and the two protrusions are pivotally mounted through by a pivoting element 16G. The eighth embodiment of the in-vehicle fixture for driving assist has a left hanging seat 22G, a right hanging seat 23G, a left contact arm 24G, a right contact arm 25G and two first connection member 3G. The left contact arm 24G and the left hanging seat 22G are two ends of one of the two bars, and the right contact arm 25G and the right hanging seat 23G are two ends of the other bar. The left hanging seat 22G and the left contact arm 24G are pivotable relative to the right hanging seat 23G and the right contact arm 25G so that a saddle portion 11G formed between the left hanging seat 22G and the right hanging seat 23G has a width adjustable function.

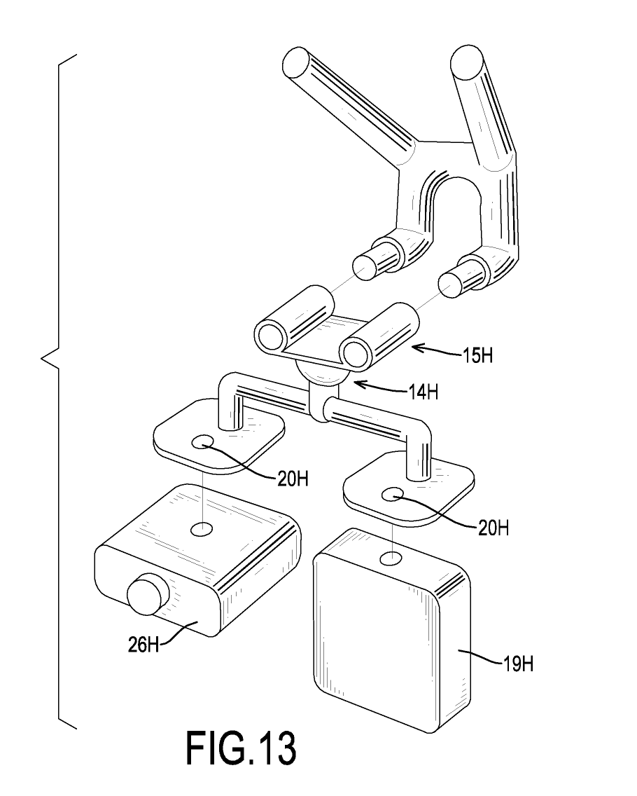

With reference to FIG. 13, a ninth embodiment of an in-vehicle fixture for driving assist devices in accordance with the present invention is redesigned based on the fourth embodiment in FIG. 6 and their difference lies in that the revolute joint 14H mounted on a bottom of the intermediate mechanism 15H has two rods. The two rods are formed on and protrude from a bottom of the revolute joint 14H respectively in two opposite directions and are respectively connected with two third connection members 20H. The two third connection members 20H are respectively connected with two driving assist devices. In the present embodiment, the two driving assist devices are a driving recorder 26H and a GPS 19H.

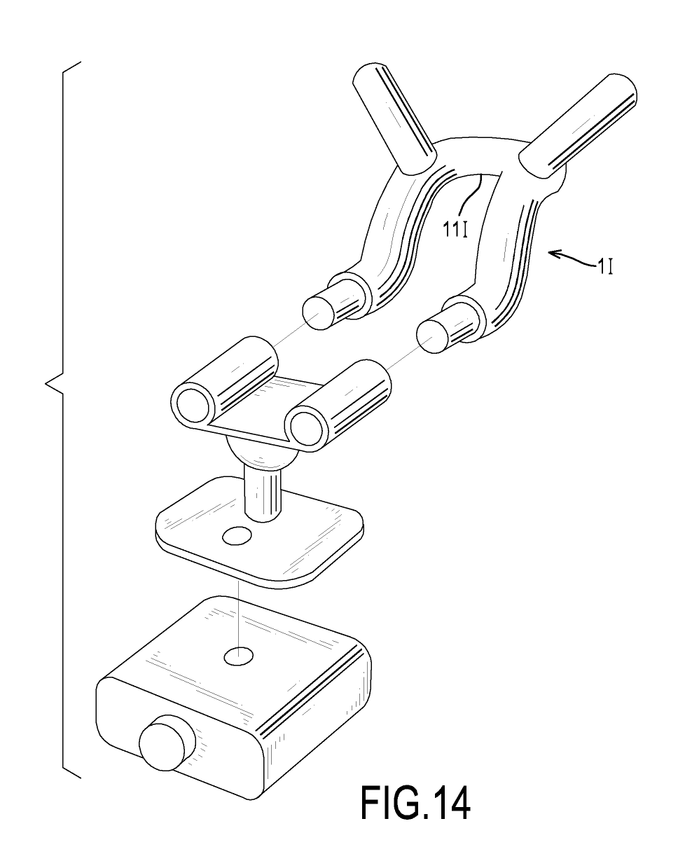

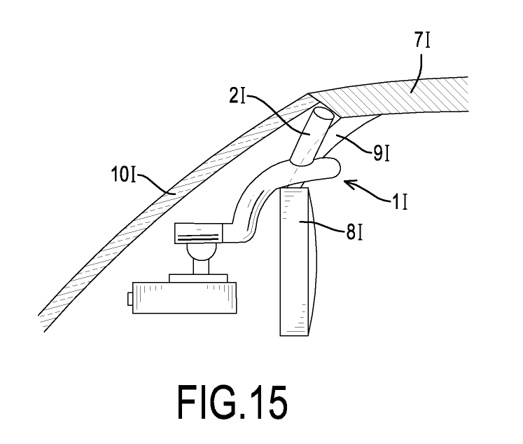

With reference to FIGS. 14 and 15, a tenth embodiment of an in-vehicle fixture for driving assist devices in accordance with the present invention is shown. As the fixing rod 9I of the rearview mirror 8I is connected to an inner roof of a vehicle, the saddle portion 11I of the hanging seat 1I is hung on the fixing rod 9I through a rear of the fixing rod 9I. One end of each contact arm 2I abuts against a junction between the inside surface of the windshield 10I and the inner roof of the vehicle. As the two contact arms 2I align in a rearward direction and abut against the junction, a rearward movement of the hanging seat 1I can be prevented so as to achieve a stable fixing effect.

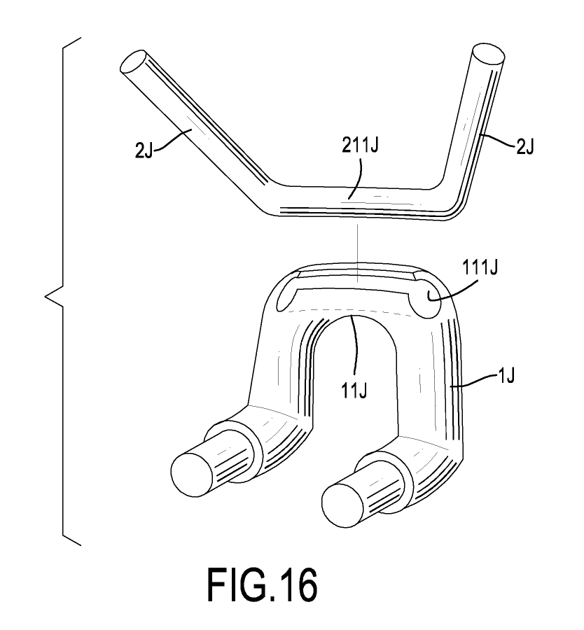

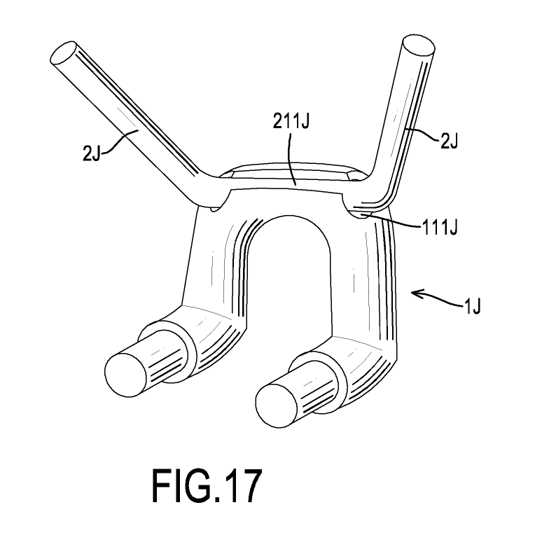

With reference to FIGS. 16 and 17, an eleventh embodiment of an in-vehicle fixture for driving assist devices in accordance with the present invention is redesigned based on the hanging seat 1 and the contact arms 2 of the first embodiment and adopts a design combining the contact arms 2 and the hanging seat 1 of the first embodiment pivotally. The hanging seat 1J has a horizontal groove 111J formed in a portion of the hanging seat 1J directly above the saddle portion 11J. A horizontal bar 211J is integrally formed between the two contact arms 2J and is equal to or slightly larger than the horizontal groove 111J in diameter. The horizontal bar 211J can be pivotally mounted in the horizontal groove 111J by a tight fit so that the horizontal bar 211J can be pivoted forwardly or rearwardly within the horizontal groove 111J as long as the force exerted on the contact arms 2J overcomes the clamping force between the horizontal bar 211J and the horizontal groove 111J. The horizontal groove 111J may be a C-shaped groove. The C-shaped groove 111J has a tight fit with the horizontal bar 211J and is pivotally combined with the horizontal bar 211J. The present embodiment is advantageous in that:

1. When the hanging seat 1J and the contact arms 2J are made of different materials and must be separately manufactured, the hanging seat 1J and the contact arms 2J can be easily and rapidly assembled and disassembled.

2. When the rearview mirror is adjacent to the windshield, the two contact arms 2J can be pivoted forwardly or rearwardly so that the in-vehicle fixture can be reduced in size to be easily mounted on the fixing rod of the rearview mirror through the space between the rearview minor and the windshield.

3. When the in-vehicle fixture is stored, the two contact arms 2J can be pivoted forwardly or rearwardly to make the in-vehicle fixture compact for storage.

4. The two contact arms 2J can be pivoted forwardly or rearwardly to abut against the inside surface of the windshield, the inner roof of a vehicle or a junction between the inner roof of the vehicle and the inside surface of the windshield in an optimized support angle.

5. The two contact arms 2J can be pivoted forwardly or rearwardly to implement the forwardly leaning contact arms 2 in FIG. 2 and the rearwardly leaning contact arms 2C in FIG. 7, thereby achieving to be multi-functional in operation and reducing the mold and warehousing cost.

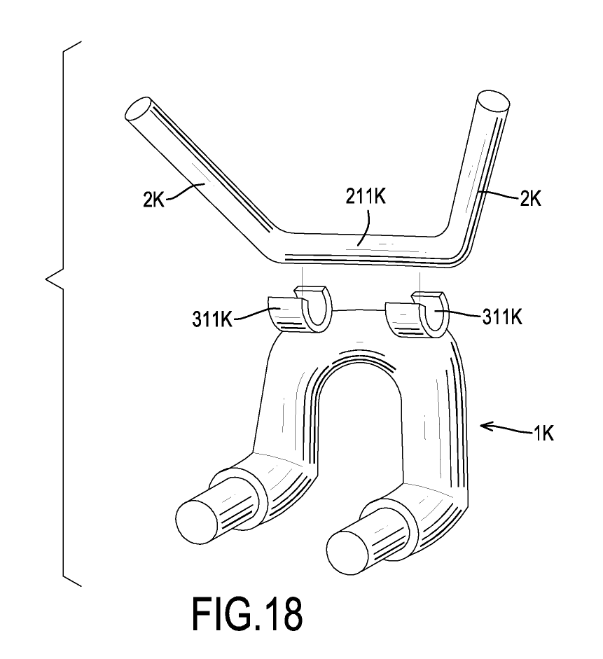

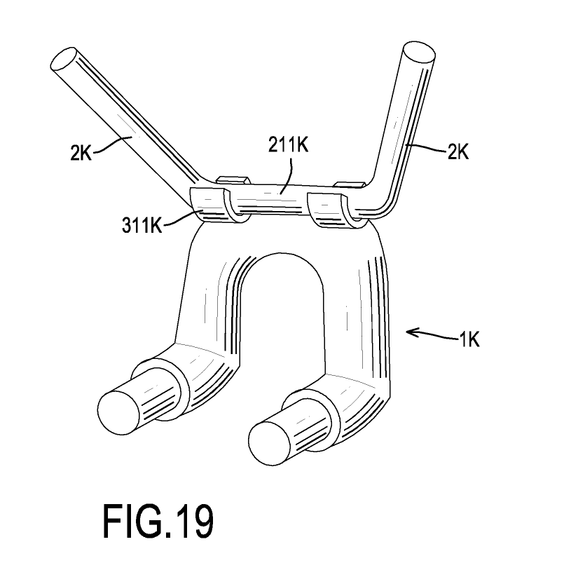

With reference to FIGS. 18 and 19, a twelfth embodiment of an in-vehicle fixture for driving assist devices in accordance with the present invention is redesigned based on the eleventh embodiment, and has at least one C-shaped collar 311K and a horizontal bar 211K. The at least one C-shaped collar 311K is formed on a top of the hanging seat 1K. The horizontal bar 211K is mounted in the at least one C-shaped collar 311K. The at least one C-shaped collar 311K is capable of clamping the horizontal bar 211K so that the two contact arms 2K can be pivoted forwardly or rearwardly. The present embodiment also has the advantages of the eleventh embodiment.

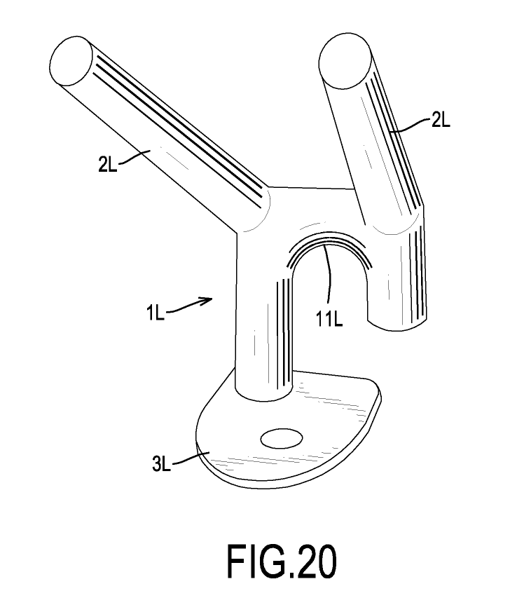

With reference to FIG. 20, a thirteen embodiment of an in-vehicle fixture for driving assist devices in accordance with the present invention has a hanging seat 1L, two contact arms 2L and a first connection member 3L. The hanging seat 1L is U-shaped and has two bars and a saddle portion 11L formed between two bars of the hanging seat 1L. The two contact arms 2L are respectively connected with tops of the two bars of the hanging seat 1L. The first connection member 3L is connected with a bottom of one of the two bars of the hanging seat 1L which is longer than the other bar of the hanging seat 1L, and the shorter bar of the hanging seat 1L has a gap for the fixing rod of the rearview mirror to pass through and the saddle portion 11L of the hanging seat 1L to be directly mounted on the fixing rod of the rearview mirror.

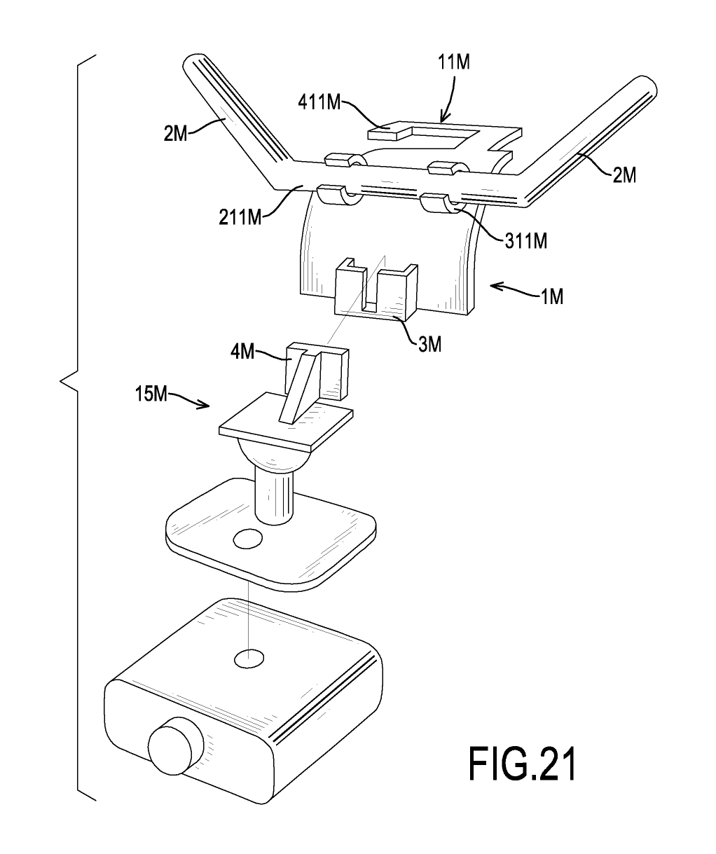

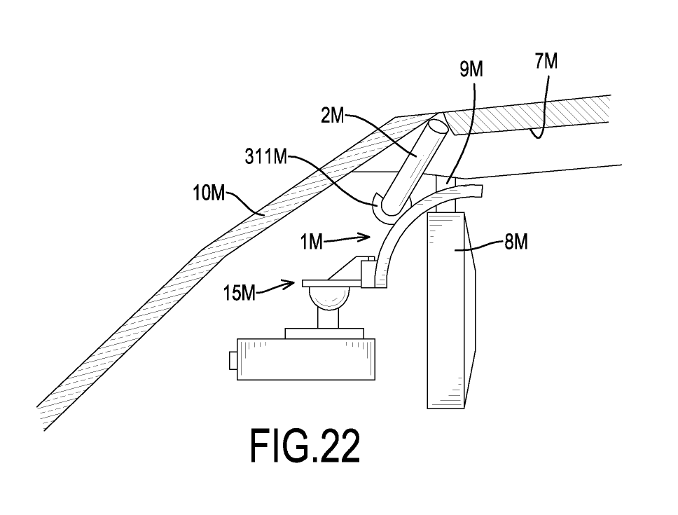

With reference to FIGS. 21 and 22, a thirteen embodiment of an in-vehicle fixture for driving assist devices in accordance with the present invention has a hanging seat 1M, two contact arms 2M, a first connection member 3 and an intermediate mechanism 15M as the inner roof 7M of the vehicle protrudes inwardly to make the fixing rod 9M of the rearview mirror 8M shorter and thus the space between the inner roof 7M and the rearview mirror smaller. The hanging seat 1M has a hook 411M and a saddle portion 11M. The hook 411M is formed on a top of the hanging seat 1M. The saddle portion 11M is formed inside the hook 411M and is hung on the fixing rod 9M through one side of the fixing rod 9M. The hanging seat 1M has at least one C-shaped collar 311M formed on the hanging seat 1M. A horizontal bar 211M is integrally formed between two contact arms 2M. The at least one C-shaped collar 311M is capable of clamping the horizontal bar 211M therein so that the two contact arms 2M can be pivoted forwardly and rearwardly. One end of each contact arm 2M abuts against a junction between the inside surface of the windshield and the inner roof of the vehicle. As the two contact arms 2M align in a rearward direction and abut against the junction, a rearward movement of the hanging seat 1M can be prevented and the hook 411M can be prevented from coming off the fixing rod of the rearview mirror to achieve a stable fixing effect. The first connection member 3M is an insertion slot, and the intermediate mechanism 15M has a second connection member 4M corresponding to the first connection member 3M. The second connection member 4M is an insertion block. The second connection member 4M is inserted in the first connection member 3M and fixed therein.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An in-vehicle fixture for driving assist device comprising:
a hanging seat having a saddle portion and adapted to be hung on a fixing rod of a rearview mirror;
at least one contact arm, wherein one end of each one of the at least one contact arm connected with the hanging seat; and
at least one first connection member formed on the hanging seat.

2. The in-vehicle fixture as claimed in claim 1, wherein the at least one first connection member is adapted to respectively connect with at least one second connection member formed on a driving assist device.

3. The in-vehicle fixture as claimed in claim 1, wherein the at least one contact arm protrudes forwardly.

4. The in-vehicle fixture as claimed in claim 1, wherein the hanging seat further has a rear nose formed on and protruding rearwardly from a rear of the hanging seat.

5. The in-vehicle fixture as claimed in claim 1, wherein the at least one contact arm protrudes rearwardly.

6. The in-vehicle fixture as claimed in claim 1, wherein the hanging seat further has a front nose formed on and protruding forwardly from a front of the hanging seat.

7. The in-vehicle fixture as claimed in claim 1, wherein the hanging seat is composed of two bars pivotally connected with each other, one bar has a left hanging seat formed on one end thereof and the other bar has a right hanging seat formed on one end thereof.

8. The in-vehicle fixture as claimed in claim 7, wherein
the two bars are crossly and pivotally connected, and
the at least one contact arm has a left contact arm and a right contact arm, the left contact arm is formed on the end of the bar away from the right hanging seat, and the right contact arm is formed on the end of the bar away from the left hanging seat.

9. The in-vehicle fixture as claimed in claim 7, wherein
each bar has a protrusion formed on and protruding from a middle portion of the bar in a direction toward the other bar, and the two protrusions are pivotally connected, and
the at least one contact arm has a left contact arm and a right contact arm, the right contact arm is formed on the end of the bar away from the right hanging seat, and the left contact arm is formed on the end of the bar away from the left hanging seat.

10. The in-vehicle fixture as claimed in claim 1, wherein the each one of the at least one contact arm is a resilient bar.

11. The in-vehicle fixture as claimed in claim 1, wherein
the hanging seat has a horizontal groove formed in a portion of the hanging seat directly above the saddle portion, and
the at least one contact arm has two contact arms, and a horizontal bar is integrally formed between two contact arms and is pivotally mounted in the horizontal groove.

12. The in-vehicle fixture as claimed in claim 1, wherein
The hanging seat has at least one C-shaped collar formed thereon, and
the at least one contact arm has two contact arms, and a horizontal bar is integrally formed between two contact arms and is pivotally mounted in the C-shaped collar.

13. The in-vehicle fixture as claimed in claim 1, wherein the hanging seat has a hook formed on a top of the hanging seat.

14. The in-vehicle fixture as claimed in claim 1 further comprising an intermediate mechanism, wherein the at least one first connection member is respectively connected with at least one third connection member formed on an intermediate mechanism.

15. The in-vehicle fixture as claimed in claim 14, wherein the intermediate mechanism further has a revolute joint.
